(19) United States
(12) Patent Application Publication
(10) Pub. No.: US 2023/0092663 A1
(43) Pub. Date: Mar. 23, 2023

(54) DEVICE, SYSTEM, AND METHOD FOR BUFFERING PROCESSOR INTERRUPTS

(71) Applicant: Intel Corporation, Santa Clara, CA (US)

(72) Inventors: Michael SHUSTERMAN, Portland, OR (US); Izoslav Slava TCHIGEVSKY, Haifa (IL); Antonio CHENG, Portland, OR (US); Hakan Magnus ERIKSSON, Portland, OR (US); Gil FAUST, Bat-Hefer (IL); Sunil KUMAR, Cupertino, CA (US); Justin MADIGAN, Folsom, CA (US); Marina SHARKANSKY, Haifa (IL); Ehud SHTALRID, Beer-Yacov (IL); Gaurav SUTARIA, Folsom, CA (US)

(21) Appl. No.: 17/481,473

(22) Filed: Sep. 22, 2021

(51) Int. Cl. G06F 3/038; G06F 3/0338; G09G 5/00; G06F 3/02; G06F 3/0354; G06F 9/48; G06F 1/3296

(52) U.S. Cl. CPC G06F 3/038; G06F 3/0338; G09G 5/006; G06F 3/0213; G06F 3/03543; G06F 9/4818; G06F 1/3296; G06F 2203/0384; G09G 2330/022

(57) ABSTRACT

Disclosed herein is system for buffering processor interrupts from active input devices, such as Bluetooth devices, so that they are aligned with a video refresh rate. The system may include a processor that operates in a first operating mode (e.g., a low power mode) and, in response to an interrupt request, switch to a second operating mode (e.g., a higher power mode). The first operating mode may be different from the second operating mode (e.g., each with a different level of power consumption). The system may also include a video subsystem, in communication with the processor, that provides video information at a refresh rate. The system may also include an input subsystem, such as a wireless communication system, in communication with the processor, that receives an activity trigger representing an activity of a input device, such as a human input device, and provides, based on the refresh rate, the activity trigger to the processor as the interrupt request.

### TECHNICAL FIELD

The disclosure relates generally to input devices, and more specifically, to devices, systems, and methods for buffering processor interrupts from input devices, such as wireless Bluetooth human interface devices.

### BACKGROUND

Today's computing systems, especially those that operate on battery power, typically include the ability for the processor to operate in a low power mode. A low power mode may be used, for example, to save battery power during periods when the processor does not need to be fully operational. In addition, many systems include input subsystems that allow the user to connect peripherals (including wireless peripherals) that may be used as a system input device, such as a keyboard, mouse, joystick, wearable device, etc. The downside of using such input devices is that they may cause the system processor to consume more power than would otherwise be desired.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 illustrates an example system timeline for buffering events and aligning them to the video refresh rate; and

FIG. 2 shows a schematic flow diagram of a method for buffering processor interrupts.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

The apparatuses and methods described herein may be implemented using a hierarchical architecture, e.g., by introducing a hierarchical prioritization of usage for different types of users (e.g., low/medium/high priority, etc.), based on a prioritized access to the spectrum (e.g., with highest priority given to tier-1 users, followed by tier-2, then tier-3, etc.).

As one of skill in the art should appreciate, Bluetooth is a widely-used, short-range wireless protocol standard that allows for the wireless exchange of data over short distances. Bluetooth operates in the 2.402 GHz to 2.48 GHz frequency band, and covers various classes of devices with varying output powers. The Bluetooth Special Interest Group (the “Bluetooth SIG”) maintains the Bluetooth standards which have evolved over time as new versions have been released, starting with Bluetooth 1.0, and currently to Bluetooth 5.2. The term “Bluetooth,” unless specific to a particular release (or an amended version of the release), is meant to encompass all past and future releases/versions of the Bluetooth standard. When a specific release is referenced, e.g., “Bluetooth 4.1,” it is meant to encompass all revisions of the specific release as well as compatible releases of the standard. As one example, the current version of the core Bluetooth specification is Bluetooth Core Specification, Rev. 5.3 (Jul. 13, 2021), published by the Bluetooth SIG.

In order for a system to use a Bluetooth-enabled device, the device must be compatible with a subset of Bluetooth profiles. A Bluetooth profile is a specification regarding aspects of Bluetooth-enabled wireless communication between devices. One example of such a Bluetooth profile is a Human Interface Device (HID) profile. The HID profile provides support for system input devices such as mice, joysticks, keyboards, wearable devices (e.g. a medial device, a medical alert device, a fitness device, a smartwatch, etc.) and buttons. HID profiles are typically designed to use a low latency Bluetooth communication link according to low power protocols, including for example Bluetooth Basic Rate/Enhanced Data Rate (BR/EDR) or Bluetooth Low Entergy (LE). The Bluetooth controller will typically poll the HID on a frequent basis in order to receive events (e.g., a movement of the mouse, a typing on a keyboard, a click of a button, etc.) from the HID and provide it to the operating system of the processor. Bluetooth controllers typically include the ability to detect the type of host traffic communicated over the Bluetooth interface by utilizing the interface to infer the application using the interface, e.g. a music stream, a HID, etc. Information associated with the type of Bluetooth traffic is typically used to support quality-of-service (QOS) requirements for the particular application, especially where multiple Bluetooth applications may be contending for airtime or where collocated WiFi interfaces may be operating in an overlapping spectrum (e.g., the 2.4 GHz unlicensed industrial, scientific, and medical radio band (ISM band)) and contending for airtime. Because a Bluetooth controller is able to infer whether the traffic over the interface is HID traffic, this capability may be used to identify HID events.

Typically, when a processor receives a HID event, the HID event may cause the processor to change to an active state. Processors generally operate in various different “states” or “modes,” where each state may be associated with a certain level of processing and therefore power consumption. These operating states are sometimes called “C-states” or “C-modes” of the processor, where each state may be numbered. For example, a CO state may be considered a fully-operational and fully-powered mode, where the processor is fully turned on and actively executing instructions. Modes or states above CO may be considered low power modes because the processor may not be actively executing instructions or may have turned off certain operations. For example, a C3 state may be a low power mode where all internal clocks of the processor are stopped. If a processor were in such a C3 state, the processor would not be able to perform any operations that require an internal clock, and the processor would need to exit the C3 state and enter a state associated with a higher level of functionality (e.g., the CO state). Another example of a lower power mode may be, for example, a C8 state, where the processor is in an idle mode, supplying certain circuitry with a reduced voltage as compared to what would be supplied in a fully-operational, full-powered state. If a processor were in such a C8 state, the processor would not be able to perform any operations that required the power-reduced circuitry, and the processor would need to exit the C8 state and enter a state associated with a higher level of functionality (e.g., the CO state) to utilize the power-reduced circuitry.

One way a processor may be instructed to change states is using what is often called an “interrupt request.” The interrupt request may inform the processor, for example, that a particular operating state is required, and the processor will then exit the current state and enter the required state. Using the exemplary C-states discussed in the previous paragraph as a continued example, assume the processor is in a C3 state. While in the C3 state, the user may wish to begin typing on the keyboard. Because the keyboard requires use of the processor's internal clock in order to properly recognize the user's keystrokes, an interrupt request may be sent to the processor so that the processor exits the C3 state and enters, for example, the CO state. In the case of a HID event described above, the HID event (e.g., an activity trigger) is or may cause an interrupt request to be sent to the processor to return to an active state, e.g., a CO state to handle the HID event.

In order to conserve power, it may be beneficial for systems to keep their processor(s) in lower power modes until a processor interrupt is received that directs the processor to return to an active state. This is not only because systems may consume more power in an active state but also because the system may consume more power in order to change a processor's operating state. For example, systems may consume about 1 Watt of power to interrupt a processor to change from a relatively idle state (e.g., the C8 state described above) to an active state (e.g., the CO state described above). Thus, to conserve power, the processor should not be interrupted to change to an active state unnecessarily.

In systems that use wirelessly connected HIDs, it is possible that the HID may cause an unnecessary interrupt. For example, depending on the type of HID, the system may poll for HID events at an interval that is faster than what can be perceived by the user of the system. For example, if a Bluetooth mouse is connected to a computing system via a Bluetooth LE connection, the system may pole for HID events and report them every 7.5 ms. For semi-active workloads, a typical result of the HID event report may be visualization of the HID event on the display for the end user (e.g., a mouse movement causes the cursor on the display to move). In this case, the HID event report may be sent to the processor every 7.5 ms, which may cause frequent interrupts to the processor. At the same time, however, systems may use displays with a refresh rate that occurs more slowly than the HID event reports. For example, a 60 frame per second (fps) display may have a refresh rate that is about 16 ms. This means that information on the display may be updated only every 16 ms, and the user will not be able to perceive mouse movements at a faster rate, even if the events are reported to the processor at the faster 7.5 ms rate. As a result, delivering the HID event every 7.5 ms to the processor may cause undesirable power consumption by causing the processor to change to an active state faster and more frequently than is necessary. If the HID event is delivered at a time that falls in the middle of a display refresh events, for example, the processor may be brought to an active state every 7.5 ms even though the information on the display is updated only every 16 ms.

According to certain aspects, the HID event reporting may be modified so that HID events are buffered for a period of time so that the processor is not interrupted to change to an active state more frequently than is necessary. For example, continuing the HID mouse example discussed above, the HID events from the mouse may be buffered so that they are provided to the processor at or near the same time as the video refresh rate. If the HID event are buffered and delivered in a way that is synchronized to the video refresh rate (e.g., near or at the same time or a multiple of the refresh rate), it may prevent delivering redundant HID events to the processor that would otherwise cause an interrupt. The buffered HID events may then be delivered, for example, after receiving an indication (e.g., a prefetch indication) from the system (e.g., a display engine or a power management controller). The indication may be aligned to the display refresh rate, for example, so that the HID events may be delivered just in time for the screen refresh, avoiding unneeded interrupts to the processor and avoiding unnecessary power consumption.

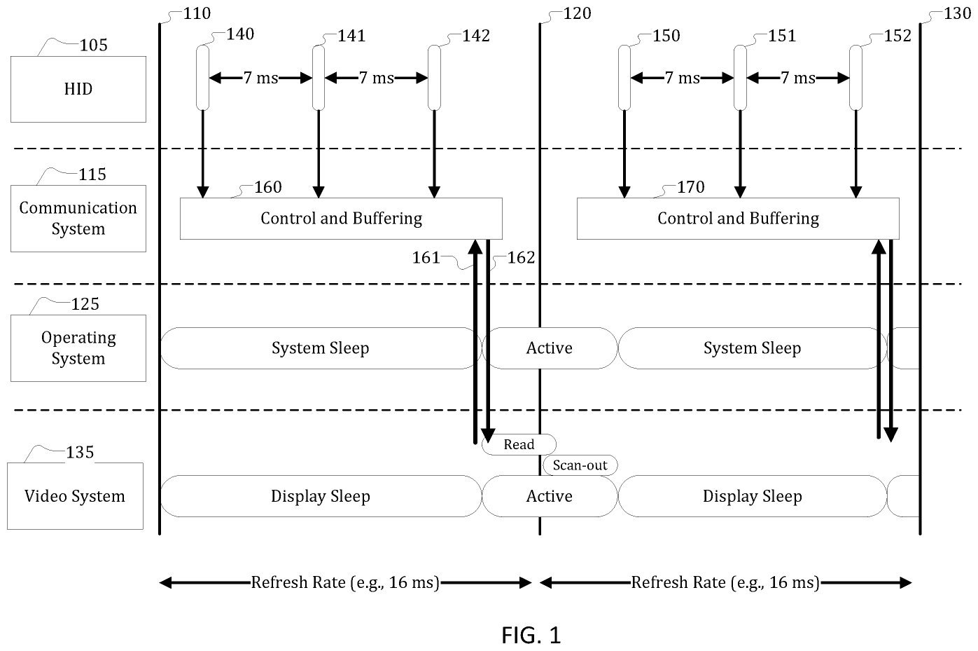

FIG. 1 illustrates a portion of an example system timeline for buffering events and aligning them to the video refresh rate. The system may include a video system 135, a processor with operating system 125, a communication system 115, and a HID 105. The communication system 115 may communicate with HID 105 using, for example, Bluetooth communication, and HID 105 may be, for example, a keyboard, a mouse, or a touchpad. Refresh lines 110, 120, and 130 indicate the time at which the video system 135 refreshes the display (e.g., a vertical blank event). In the portion of the example timeline shown, the video refresh occurs approximately every 16 ms, although it should be appreciated that the video system 135 may have any refresh rate, periodic or aperiodic. As the user operates the HID 105, it may generate any number of HID events, which are shown in FIG. 1 as HID events 140, 141, 142, 150, 151, and 152. If HID 105 is a mouse, for example, the HID events may be mouse movements or button presses. If HID 105 is a keyboard, for example, the HID events may be key presses. As can be seen in the example of FIG. 1, the HID events occur at a frequency of every 7 ms, which is more frequent than the refresh rate of 16 ms, although it should be appreciated that HID 105 may have any number of HID events at any frequency, periodic or aperiodic.

When HID events 140, 141, and 142 occur, the video system 135 and operating system 125 may be in sleep states, as shown in FIG. 1. As discussed above, when the operating system 125 is in a sleep state, this means that the processor may operate in a lower power mode and may consume less power than in a higher power mode associated with other, non-sleep states. When video system 135 is in a sleep state, this means that the video display may not updated during the period labeled “Display Sleep,” and the user may not be able to perceive any HID events related to the display that occur during this period. If one of the HID events 140, 141, 142 were to be provided to the processor with operating system 125 at the time each event occurred, each event would cause the processor to exit the “System Sleep” mode, but the activity associated with the event would not be perceived by the user because the video display is not updated during this time period. As such, it would cause unnecessary power consumption if such events were delivered to the processor during the “Display Sleep” period.

To prevent such unnecessary power consumption, the HID events 140, 141, 142 may be buffered by the communication system 115 in the control and buffering period 160 until the video system 135 (and the operating system 115) enters an Active Period. The communication system 115 may be informed of the timing for the Active Period through the use of a message 161 (e.g., a prefetch message) that indicates to the communication system 115 the timing of the Active Period. Once the communication system 115 knows the timing of the Active Period, the communication system 115 may deliver the buffered HID events 140, 141, 142 (e.g., in message 162) so they may be read by the operating system and scanned out to the display connected to video system 135 during the Active Period. It should be appreciated that the control and buffering period (e.g., control and buffering period 160) may deliver some, all, or none of the buffered HID events (e.g., HID events 140, 141, 142) to the video system 135, depending on the type of HID event and whether later HID events are redundant or make earlier HID events superfluous. In addition, the communication system 135 may decide whether to buffer a given event based on a priority of the HID event, where, for example, higher priority HID events may be immediately delivered to the processor while lower priority events may be buffered until a subsequent video refresh event. This buffering process may be repeated at the refresh rate of the video system 135, which may be periodic or aperiodic. For example, in the next period (e.g., between the next set of vertical blank events represented by refresh lines 120 and 130), HID events 150, 151, and 152 are buffered by the communication system 115 in control and buffering period 170 until the video system 135 and the operating system 115 reenter an Active Period (not labeled in FIG. 1). In an ideal scenario, the processor with operating system 115 may be allowed to reside continuously in a lower power state for the duration of time between vertical blank events (e.g., between refresh lines 110 and 120 and between refresh lines 120 and 130) of the video system 135. It should be appreciated by those of skill in the art, that the timing for delivery of buffered HID events may also depend on other factors, including but not limited to, for example, the type of HID event, the type of application associated with the HID event, the importance of the HID event to other operations, etc.

The communication system 115 may be informed of the timing of the next video refresh event in any manner. As depicted in FIG. 1, message 162 may used to inform the communications system 115 of the impending refresh event. Such a message may be referred to as a prefetch indication. Preferably, the prefetch indication allows enough time in advance of the screen refresh scan out to allow the video system 135 sufficient time to process and render the HID event or events so that the HID event or events may be visualized in the immediately following frame. As one example, the prefetch indication may be based on an Optimized Buffer Flush/Fill (OBFF), as specified, for example, in the Peripheral Component Interconnect Express (PCIe) Base Specification (e.g., PCI Express Base Specification Revision 5.0, Version 1.0 (May 28, 2019), published by the PCI Special Interest Group, and in particular, sections 2.2.8.9 and 6.19). The OBFF Message is optionally used to report platform central resource states to endpoints, and it may also be used (e.g., as a phase transition report) to convey the prefetch indication to the Bluetooth engine of the communications system 115. For example, the OBFF defines the following phases: Active Window (AW), Direct Memory Access (DMA) Window (DM), and Idle Window (IW). In the AW phase, the memory path is open, the processor is active, and the system is in its most active state, where memory traffic and processor interrupts are allowed. In the DW phase, processor is in a sleep state, but memory traffic is allowed. In the DW phase, interrupts or other processor events that cause the processor to exit the sleep state are not recommended. In the IW phase, neither memory traffic nor processor interrupts are recommended. With such phases in mind, the prefetch indicator could be inferred from, for example, detecting a transition from the IW phase to the AW phase.

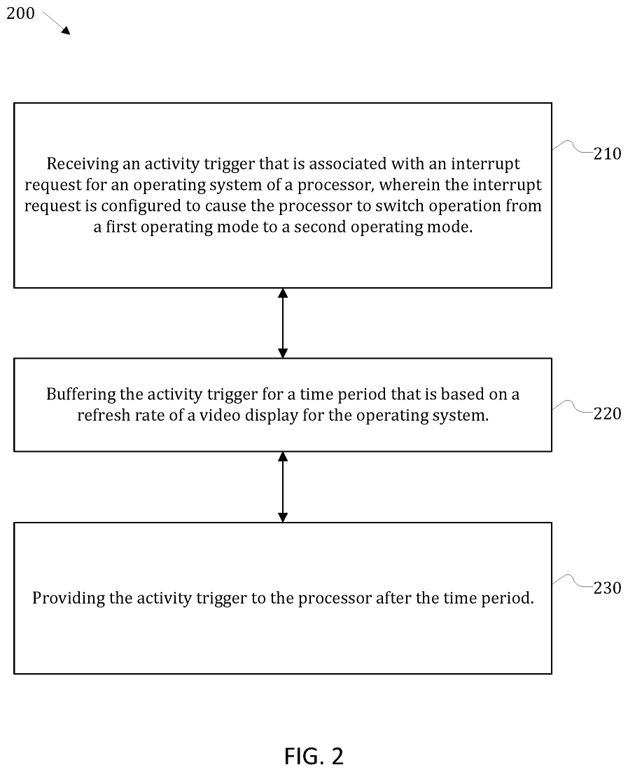

FIG. 2 depicts a schematic flow diagram of a method 200 for buffering processor interrupts. Method 200 is a method for buffering processor interrupts and includes, in 210, receiving an activity trigger that is associated with an interrupt request for an operating system of a processor. The interrupt request is configured to cause the processor to switch operation from a first operating mode to a second operating mode, and the first operating mode is different from the second operating mode. The method 200 further includes, in 220, buffering the activity trigger for a time period that is based on a refresh rate of a video display for the operating system. The method 200 further includes, in 230, providing the activity trigger to the processor after the time period.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1. A computing system comprising:
a processor configured to operate in a first operating mode;
a video subsystem in communication with the processor, wherein the video subsystem is configured to provide video information at a refresh rate; and
an input subsystem in communication with the processor, wherein the input subsystem is configured to:
receive an activity trigger representing an activity on an input device, and
provide, based on the refresh rate, the activity trigger to the processor as an interrupt request, wherein the interrupt request is configured to cause the processor to switch to a second operating mode, which is different from the first operating mode.

2. The computing system of claim 1, wherein the input subsystem is further configured to buffer the activity trigger for a duration of at least one cycle of the refresh rate before providing the activity trigger to the processor as the interrupt request.

3. The computing system of claim 1, wherein the first operating mode comprises a low power mode in which the processor is configured to consume less power than when operating in the second operating mode.

4. The computing system of claim 1, wherein the input subsystem is further configured to:
receive a prefetch message indicating the refresh rate; and
provide, after receiving the prefetch message, the activity trigger to the processor as the interrupt request.

5. The computing system of claim 4, wherein the prefetch message comprises a phase transition report indicating a phase state change from a first state of resources associated with the processor to a second state of resources associated with the processor, wherein the first state is different from the second state.

6. The computing system of claim 1, wherein the input subsystem comprises a Bluetooth controller and the input devices comprises a wireless input device, wherein the Bluetooth controller is configured to communicate with the wireless input device via a Bluetooth protocol.

7. The computing system of claim 6, wherein the input device comprises a human interface device in wireless communication with the Bluetooth controller via the Bluetooth protocol.

8. The computing system of claim 7, wherein the human interface device comprises at least one of a keyboard, a mouse, a joystick, a touchpad, a button, and/or a wearable device.

9. The computing system of claim 1, wherein the refresh rate comprises a duration of time between updating a display with the video information.

10. The computing system of claim 1, wherein the input subsystem is further configured to provide the activity trigger to the processor based on a priority of the activity trigger.

11. An apparatus comprising
a receiver configured to receive an activity trigger that is associated with an interrupt request for an operating system of a processor, wherein the interrupt request is configured to cause the processor to switch operation from a first operating mode to a second operating mode, wherein the first operating mode is different from the second operating mode;
a controller in communication with the receiver, wherein the controller is configured to:
buffer the activity trigger for a time period, wherein the time period is based on a video refresh rate associated with the operating system, and
provide, after the time period, the activity trigger to the processor.

12. The apparatus of claim 11, wherein the time period comprises a duration of at least one cycle of the refresh rate.

13. The apparatus of claim 11, wherein the activity trigger comprises an event received from a human interface device in wireless communication with the controller.

14. The apparatus of claim 11, wherein the controller is further configured to:
receive a prefetch message indicating the video refresh rate, and
provide, after receiving the prefetch message, the activity trigger to the processor as the interrupt request.

15. The computing system of claim 14, wherein the prefetch message comprises a phase transition report indicating a phase state change from a first state of resources associated with the processor to a second state of resources associated with the processor, wherein the first state is different from the second state.

16. The computing system of claim 11, wherein the controller comprises a Bluetooth controller configured for wireless communication with a human interface device via a Bluetooth protocol.

17. A non-transitory computer readable medium, comprising instructions which, if executed, cause one or more processors to:
receive an activity trigger that is associated with an interrupt request for an operating system of a processor, wherein the interrupt request is configured to cause the processor to switch operation from a first operating mode to a second operating mode, wherein the first operating mode is different from the second operating mode;
buffer the activity trigger for a time period, wherein the time period is based on a refresh rate of a video display for the operating system; and
provide the activity trigger to the processor after the time period.

18. The non-transitory computer readable medium of claim 17, wherein the time period comprises a duration of at least one cycle of the refresh rate.

19. The non-transitory computer readable medium of claim 17, wherein the refresh rate comprises a duration of time between vertical blank events of the video display.

20. The computing system of claim 17, wherein the time period is further based on a priority of the activity trigger.
